(19) United States
(12) Patent Application Publication
(10) Pub. No.: US 2017/0101967 A1
(43) Pub. Date: Apr. 13, 2017

(54) PRECHAMBER INTERNAL REFORMER CATALYST

(71) Applicant: Caterpillar Inc., Peoria, IL (US)

(72) Inventor: Andrew Loetz, West Lafayette, IN (US)

(73) Assignee: Caterpillar Inc., Peoria, IL (US)

(21) Appl. No.: 14/881,710

(22) Filed: Oct. 13, 2015

(51) Int. Cl. F02M 27/02; F02B 19/18

(52) U.S. Cl. CPC F02M 27/02; F02B 19/18

(57) ABSTRACT

An internal combustion engine having a main combustion chamber, a prechamber and a fuel supply system is disclosed. The main combustion chamber is in fluid communication with the prechamber. The fuel supply system is connected to the prechamber for introducing fuel into the prechamber. Further, the fuel supply system has a catalyst to reform the fuel prior to introduction in the prechamber.

### TECHNICAL FIELD

The present disclosure relates to an internal combustion engine. In particular, the present disclosure relates to a coating or catalyst elements disposed in a fuel supply system to the prechamber for reforming a portion of the charge.

### BACKGROUND

Internal combustion engines often emit harmful oxides of nitrogen (“NOₓ”) during operation. These oxides form when nitrogen and oxygen, both of which are present in the air used for combustion, combine within the main combustion chambers. Typically, the level of NOₓ formed increases as the peak combustion temperatures within the combustion chambers increase. As such, minimizing the peak combustion temperatures within the main combustion chambers generally reduces the emission of NOₓ.

For this reason, leaner fuel mixtures are used for reducing the peak combustion temperatures in the main combustion chamber, thus reducing the amount of harmful NOₓ emitted. A lean fuel mixture has a relatively large air-to-fuel ratio when compared to a stoichiometric air-to-fuel ratio. Accordingly, using more air in the fuel mixture may advantageously lower NOₓ emissions.

Further, most internal combustion engines use an ignition plug to ignite the air/fuel mixture periodically in the engine cycle. However, as the size of the combustion chamber increases, the effectiveness of ignition plugs to induce combustion is diminished. This is due in part because the arc generated by the ignition plug is very localized. The situation is exacerbated when the air/fuel ratio is made lean in an effort to reduce emissions and increase fuel efficiency. In a large combustion chamber, for example, it may take an undesirable period of time for the combustion process to propagate throughout the combustion chamber. Furthermore, using a lean air-to-fuel ratio may result in incomplete combustion i.e. lean misfire within the main combustion chamber. Moreover, turbulence within the main combustion chamber may extinguish the ignition flame before the lean air-fuel mixture combusts. Lean misfire in the engine causes reduced power output and an increase in the amount of un-combusted fuel. In some cases extinguishing of the ignition flame leads to the engine coming to a halt.

To minimize the occurrence of incomplete combustion, some internal combustion engines incorporate a precombustion chamber, or prechamber. Either enriched or non-enriched fuel may be advanced in these prechambers. Ignition of the fuel within the prechamber creates a jet of burning fuel that is directed into the main combustion chamber, thus igniting the lean air-fuel mixture within the main combustion chamber. However, the jet flame from the prechamber may not have sufficient flame speed near the lean air-fuel mixture within the main combustion chamber. This may lead to breakdown in the combustion process.

U.S. Pat. No. 5,611,307 discloses an internal combustion engine having a combustion chamber and prechamber. The prechamber has a reforming catalyst that generates a rapidly combustible hydrogen rich mixture.

### SUMMARY OF THE INVENTION

In an aspect of the present disclosure, an internal combustion engine having a main combustion chamber, a prechamber and a fuel supply system is disclosed. The main combustion chamber is in fluid communication with the prechamber. The fuel supply system is connected to the prechamber for introducing fuel into the prechamber. Further, the fuel supply system has a catalyst to reform the fuel prior to introduction in the prechamber.

In another aspect of the present disclosure, a fuel supply system for a prechamber of an internal combustion engine is disclosed. The fuel supply system has an inlet for receiving fuel, a catalyst to receive fuel from the inlet and reform at least a portion of the fuel and an outlet in fluid communication with an inlet of the prechamber to introduce the reformed fuel into the prechamber.

In yet another aspect of the present disclosure, a method of introducing fuel into an internal combustion engine is disclosed. The internal combustion engine has a main combustion chamber in fluid communication with a prechamber. A fuel supply system is connected to the prechamber to introduce fuel into the prechamber. The fuel supply system has a catalyst. The method includes supplying fuel to the fuel supply system, reforming a portion of the fuel by the catalyst and introducing the reformed fuel into the prechamber.

### BRIEF DESCRIPTION OF THE DRAWINGS

FIG. 1 illustrates a cross-sectional view of an internal combustion engine according to an embodiment of the present invention, in which a fuel supply system has a catalyst element.

FIG. 2 illustrates a cross-sectional view of an internal combustion engine according to an alternate embodiment of the present invention in which a fuel supply system and a prechamber have a catalyst element.

FIG. 3 depicts a method of reforming fuel within a prechamber according to an embodiment of the present invention.

### DETAILED DESCRIPTION

Reference will now be made in detail to embodiments of the invention, examples of which are illustrated in the accompanying drawings. Wherever possible, the same reference numbers will be used throughout the drawings to refer to the same or like parts.

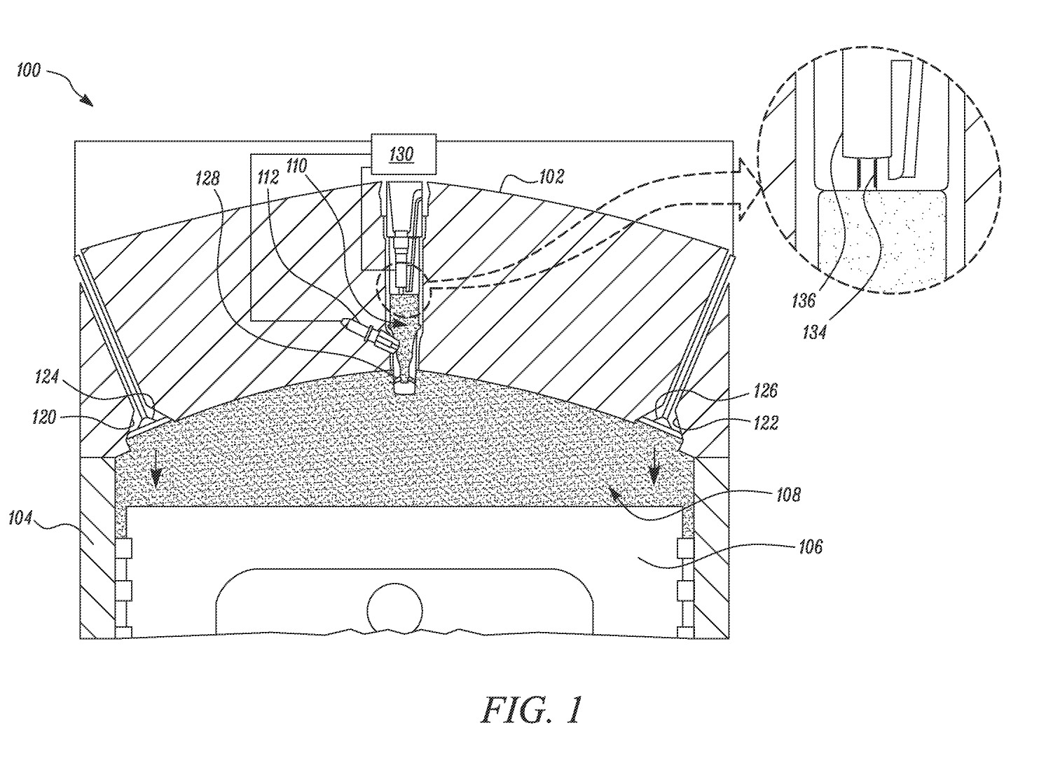

The present disclosure relates to an internal combustion engine for improving the combustion process and avoiding misfire. FIG. 1 illustrates an exemplary engine 100 configured to power any vehicle. In the exemplary embodiment, the engine 100 may be an internal combustion engine for a ground engaging machine. In various other embodiments, the engine 100 may be any engine running on solid, liquid or gaseous fuel, used for various purposes such as an automobile, a construction machine, any transportation vehicle and the like.

Referring to FIG. 1, a first embodiment of an internal combustion engine 100 includes a cylinder head 102 and a cylinder block 104. The cylinder head 102, the cylinder block 104 and a piston 106 form a main combustion chamber 108. The main combustion chamber is configured to receive fuel/air-fuel mixture i.e. charge. The charge is burnt and the piston 106 is configured to transmit the driving force created by the burning charge to an output shaft (not shown).

The main combustion chamber 108 is in fluid communication with a prechamber 110. The prechamber 110 has a capacity that is smaller than that of the main combustion chamber 108. The prechamber 110 is configured to receive either enriched or non-enriched charge. Ignition of the charge within the prechamber 110 creates a jet of burning charge that is directed into the main combustion chamber 108, thus igniting the lean charge within the main combustion chamber 108. In an embodiment, the prechamber 110 may be of spherical shape to promote swirl inside the prechamber 110. As one of skill in the art will appreciate, the prechamber 110 may be of any other type or shape known in the art. In the embodiment illustrated, the prechamber 110 is disposed at substantially a central portion of the main combustion chamber 108. In various other embodiments, the prechamber 110 be connected with the main combustion chamber 108 at other locations.

An ignition plug 112 is disposed in the prechamber 110. The ignition plug 112 may be connected with the prechamber 110 by welding or other methods known in the art. The ignition plug 112 is disposed at the top of the prechamber 110. In an alternate embodiment, the ignition plug 112 is disposed at the end of the prechamber 110, near the entrance to the main combustion chamber 108. In various other embodiments the ignition plug 112 may be disposed at other locations in the prechamber 110. The ignition plug 112 may be a typical J-gap spark plug, rail plug, extended electrode, or laser plug or any other type of spark plug known in the art.

A fuel supply system 136 is connected to the prechamber 110. The fuel supply system 136 is configured to allow fuel to flow into the prechamber 110. In the embodiment illustrated the fuel supply system is a charge valve. In the embodiment illustrated the fuel supply system 136 includes a fuel conduit. As one of skill in the art will appreciate, the fuel supply system 136 may be any structure or system known in the art for introducing fuel into the prechamber 110. In various other embodiments, the fuel supply system 136 may be any type of fuel check valve.

A catalyst element 134 is provided in the fuel supply system 136. The catalyst element 134 is configured to reform a portion of the fuel into carbon monoxide (CO) and hydrogen (H₂). The carbon monoxide and hydrogen, formed by the catalyst element 134, are highly combustible and improve ignitability of the charge in the prechamber 110. Further, the reformed fuel i.e. carbon monoxide and hydrogen have a faster flame speed than the regular fuel injected through the fuel supply system 136. In various other embodiments, the catalyst element 134 may reform the fuel into various other products that have better flame speed and improve ignitability of the lean charge. In the embodiment illustrated, the catalyst element 134 is provided at the mouth of the fuel supply system 136. In various other embodiments the catalyst element 134 may be disposed along the inner surfaces of the fuel supply system 136. In other embodiments, the catalyst element 134 may be disposed at any other location on the fuel supply system 136.

In the embodiment illustrated, the catalyst element 134 is an insert. In other embodiments, the catalyst element 134 is a coating. Further, in the embodiment illustrated the catalyst element 134 is a partial oxidation catalyst. In various other embodiments, any other catalyst which may reform the fuel present in the prechamber may be disposed in the fuel supply system 136.

In an alternate embodiment, the prechamber 110 also has a catalyst element 134. The catalyst element 134 may be disposed on the inner wall of the prechamber 110. In various other embodiments, the catalyst element 134 may be disposed at any other location within the prechamber 110.

The cylinder head 102 includes an intake port 120 and an exhaust port 122. A charge intake valve 124 is disposed on the intake port 120. The charge intake valve 124 may be driven by an intake cam (not shown) to control the supply of the charge to the main combustion chamber 108. When the charge intake valve 124 is positioned in an open position the, the intake port 120 is in fluid communication with the main combustion chamber 108. Further, the charge intake valve 124 in the open position facilitates the introduction of charge through the intake port 120 and into the main combustion chamber 108. When the charge intake valve 124 is in a closed position, the intake port 120 is isolated from the main combustion chamber 108 thereby preventing charge from entering the main combustion chamber 108 via intake port 120.

An exhaust valve 126 may be disposed on the exhaust port 122. The exhaust valve 126 may be driven by an exhaust cam (not shown) to control the discharge of the combustion products from the main combustion chamber 108. When the exhaust valve 126 is in an open position, the exhaust port 122 is in fluid communication with the main combustion chamber 108. Further, the exhaust valve 126 in the open position allows the exhaust/combusted gases to advance from the main combustion chamber 108 and into the exhaust port 122. When the exhaust valve 126 is in a closed position the exhaust port 122 is isolated from the main combustion chamber 108 and prevents charge from exiting the main combustion chamber 108 and into the exhaust port 122.

The main combustion chamber 108 and the prechamber 110 are in fluid communication with each other through at least one communication passage 128. The charge that is injected from the charge intake valve 124 is supplied to the main combustion chamber 108 as fresh charge, and may also be supplied to the prechamber 110 via the at least one communication passage 128.

The engine 100 has an electronic control unit (ECU) 130. The electronic control unit ECU 130 may be a digital computer that may include a central processing unit (CPU), a read-only-memory (ROM), a random access memory (RAM), and an output interface. The ECU 130 receives input signals from various sensors (not illustrated) that represent various engine operating conditions. For example, an accelerator opening signal from an accelerator opening sensor may detect engine load, a water temperature signal from a water temperature sensor may detect engine temperature, and a crank angle signal from a crank angle sensor may detect the angular position of a crankshaft (not shown), and which may be used by the ECU 130 to calculate engine rotation speed (e.g., number of revolutions per minute of the engine 100). In response to the input signals, the ECU 130 controls various parameters that govern operation of the engine 100. For example, the ECU 130 may control the amount and timing of the charge injected by the charge intake valve 124, the ignition timing of the ignition plug 112 (i.e., ignition of the charge in the prechamber 110). Further, ECU 130 is electrically connected to the fuel supply system 136. The ECU 130 may also control the amount and timing of the fuel injected by the fuel supply system 136.

The working of the engine 100 along with the ECU 130 will now be explained in detail with reference to FIG. 1. The ECU 130 generates an output signal that causes the charge intake valve 124 to allow enriched or non-enriched charge to advance into the main combustion chamber 108.

Simultaneously, the ECU 130 generates an output signal that causes the fuel supply system 136 to allow fuel to advance into the prechamber 110. On its way into the prechamber 110, the fuel comes in contact with the catalyst element 134 of the fuel supply system 136. This catalyst element 134 reforms at least a portion of the fuel into CO and H₂. Referring to FIG. 1, once the charge and the fuel is advanced into the main combustion chamber 108 and the prechamber 110 respectively, the ECU 130 generates an output signal that causes the ignition plug 112 to create a spark in the prechamber 110. The spark from the ignition plug 112 ignites the reformed fuel within the prechamber 110, which generates a flame jet i.e. a front of burning reformed fuel. This flame jet from the reformed fuel advances through the at least one communication passage 128 and into the main combustion chamber 108.

The flame jet entering the main combustion chamber 108 ignites the hot charge within main combustion chamber 108, thereby driving the piston 106 downward so as to rotate the crankshaft of the engine 100 for producing mechanical output. Since, the flame jet from the prechamber 110 is propagated through the main combustion chamber 108 at a faster flame speed, the probability of complete combustion of charge present in the main combustion chamber is improved. Further, faster propagation of the flame jet in the main combustion chamber 108 and the prechamber 110 improves the chances of igniting the lean mixture. Thus, improving ignitability of the lean charge present in the prechamber 110 and the main combustion chamber 108.

### INDUSTRIAL APPLICABILITY

Power producing units such as diesel engines, gasoline engines, and gaseous fuel-powered engines require an optimum amount of air/air-fuel mixture to produce high power at a high efficiency. However, these engines often emit harmful oxides of nitrogen (“NOₓ”) during operation. These oxides form when nitrogen and oxygen, both of which are present in the air used for combustion, combine within the main combustion chambers. Since the level of NOₓ formed increases as the peak combustion temperatures within the combustion chambers increase leaner fuel mixtures are used for reducing the peak combustion temperatures in the main combustion chamber, thus reducing the amount of harmful NOₓ emitted. However, a leaner fuel mixture causes lean misfire inside the engine. This misfiring leads to reduced power output and an increase in the amount of un-combusted fuel. In order to maximize the power output generated by the combustion process in the engine and minimize the occurrence of incomplete combustion, some internal combustion engines incorporate a precombustion chamber, or prechamber. Ignition of the fuel within the prechamber creates a jet of burning fuel that is directed into the main combustion chamber, thus igniting the lean air-fuel mixture within the main combustion chamber. However, a slow frame speed of the flame jet provides for a variation in time for ignition kernels thereby not being able to provide for complete combustion of the charge present in the main combustion chamber.

In an aspect of the present disclosure, the catalyst element 134 is provided on the fuel supply system 136 as shown in FIG. 1. The catalyst element 134 reforms at least a portion of the fuel introduced in the prechamber 110 by the fuel supply system 136. This reformed fuel with better ignition properties, when ignited has a faster flame speed and improves ignitability of the lean charge present in the prechamber 110 and the main combustion chamber 108. Further, since the flame speed of the flame jet produced by igniting the reformed fuel is greater than that of the flame jet generated by the unreformed fuel, variation in the time for ignition kernel growth is substantially reduced. This virtually eliminates cycle-by-cycle variation in combustion under idle and light load conditions.

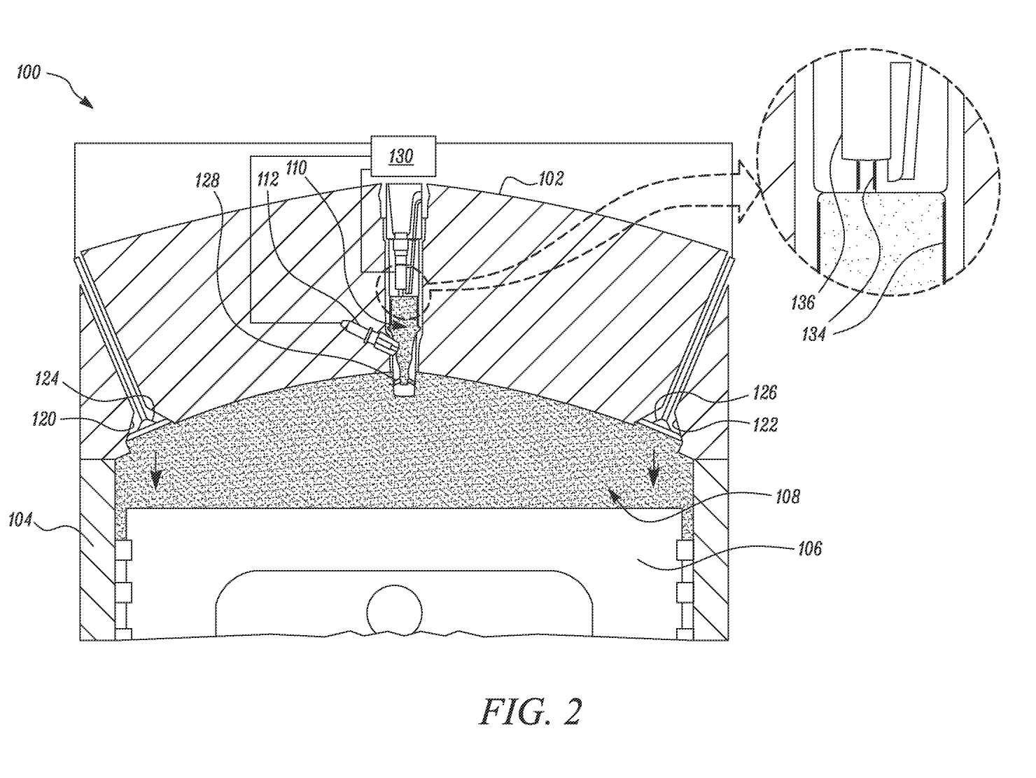

In another aspect of the present disclosure, the catalyst element 134 is provided at the mouth of the fuel supply system 136 as well as in the prechamber 110 as shown in FIG. 2. Since the fuel exits from the mouth of the fuel supply system 136, at least some of the fuel is reformed on its way into the prechamber 110. This provides a faster ignitable mixture of charge that prevents lean misfire. A worn out catalyst element 134 can be easily replaced on the fuel supply system 136 by removing the fuel supply system 136 from the engine 100.

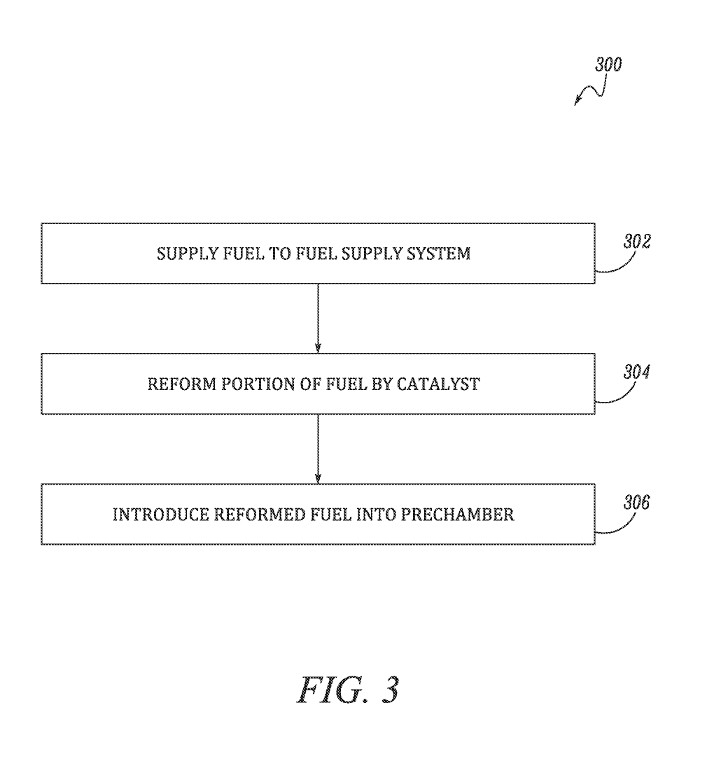

The method 300 of introducing fuel into the internal combustion engine 100 will now be described in detail with reference to FIG. 3. The fuel supply system 136 receives fuel from a fuel source (not shown) (Step 302). The fuel introduced in the fuel supply system 136 comes in contact with the catalyst element 134. The catalyst element 134 reforms a portion of the fuel that comes in contact with the catalyst element 134 (Step 304). The reformed fuel is then introduced into the prechamber 110 for combustion (Step 306).

While aspects of the present disclosure have seen particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An internal combustion engine comprising:
a main combustion chamber in fluid communication with a prechamber; and
a fuel supply system connected to the prechamber for introducing fuel into the prechamber, the fuel supply system having a catalyst to reform the fuel prior to introduction in the prechamber.

2. The internal combustion engine of claim 1, wherein the fuel supply system includes a charge valve.

3. The internal combustion engine of claim 1, wherein the fuel supply system includes a fuel conduit.

4. The internal combustion engine of claim 1, wherein the catalyst is proximate to an outlet of the fuel supply system.

5. The internal combustion engine of claim 1, wherein the prechamber is provided with the catalyst to reform the fuel.

6. The internal combustion engine of claim 1, wherein the catalyst is a coating applied to the fuel supply system.

7. The internal combustion engine of claim 1, wherein the catalyst is an insert mounted in the fuel supply system.

8. The internal combustion engine of claim 1, wherein the catalyst is a partial oxidation catalyst.

9. A fuel supply system for a prechamber of an internal combustion engine comprising:
an inlet for receiving fuel;
a catalyst configured to receive fuel from the inlet and reform at least a portion of the fuel; and
an outlet in fluid communication with an inlet of the prechamber and configured to introduce the reformed fuel into the prechamber.

10. The fuel supply system of claim 9, wherein the fuel supply system includes a charge valve.

11. The fuel supply system of claim 9, wherein the fuel supply system includes a fuel conduit.

12. The fuel supply system of claim 9, wherein the catalyst is proximate to the outlet of the fuel supply system.

13. The fuel supply system of claim 9, wherein the prechamber is provided with the catalyst to reform the fuel.

14. The fuel supply system of claim 9, wherein the catalyst is a coating applied to the fuel supply system.

15. The fuel supply system of claim 9, wherein the catalyst is a partial oxidation catalyst.

16. The fuel supply system of claim 9, wherein the catalyst is an insert mounted in the fuel supply system.

17. A method of introducing fuel into an internal combustion engine, the internal combustion engine having a main combustion chamber in fluid communication with a prechamber, and a fuel supply system connected to the prechamber for introducing fuel into the prechamber; the method comprising:
supplying fuel to the fuel supply system;
reforming a portion of the fuel by a catalyst in the fuel supply system; and
introducing the reformed fuel into the prechamber.

18. The method of claim 17, further comprising igniting the reformed fuel in the prechamber to form a flame jet directed into the main combustion chamber.

19. The method of claim 17, further comprising reforming the fuel in the prechamber.
